(19) United States
(12) Patent Application Publication
(10) Pub. No.: US 2016/0138489 A1
(43) Pub. Date: May 19, 2016

(54) HIGH-PRESSURE PUMP AND FUEL INJECTION SYSTEM HAVING A HIGH-PRESSURE PUMP

(71) Applicant: ROBERT BOSCH GMBH, Stuttgart (DE)

(72) Inventor: Marco Lamm, Leonberg (DE)

(21) Appl. No.: 14/900,658

(22) PCT Filed: Jun. 13, 2014
(86) PCT No.: PCT/EP2014/062340

§ 371 Date: Dec. 22, 2015

(30) Foreign Application Priority Data
Jun. 26, 2013 (DE) 10 2013 212 302.7

(51) Int. Cl. F02D 17/02; F04B 19/22; F02M 59/02; F04B 53/10; F04B 53/16; F04B 49/22; F02D 41/30; F04B 23/06

(52) U.S. Cl. CPC F02D 17/02; F02D 41/3082; F02D 41/30; F04B 19/22; F04B 23/06; F04B 53/10; F04B 53/16; F04B 49/22; F02M 59/02

(57) ABSTRACT

A high-pressure pump (2), which is used in particular as a radial or in-line piston pump for fuel injection systems of air-compressing, auto-ignition internal combustion engines (3), comprises a first pump assembly (8), a second pump assembly (9), and a drive shaft (6), which is used to drive the first pump assembly (8) and the second pump assembly (9). Furthermore, a first inlet valve (10) for a pump working chamber (11) of the first pump assembly (8) and at least one second inlet valve (14) for a pump working chamber (15) of the second pump assembly (9) are provided. The first inlet valve (10) is designed as a controlled inlet valve (10), wherein fuel pumping by the first pump assembly (8) can be at least substantially interrupted by the first inlet valve (10) in a partial-load operating mode. The invention further relates to a fuel injection system (1) having such a high-pressure pump (2).

### BACKGROUND OF THE INVENTION

The invention relates to a high-pressure pump, in particular a radial or in-line piston pump, as well as to a fuel injection system having such a high-pressure pump. The invention specifically relates to the area of fuel pumps for fuel injection systems of air-compressing, auto-ignition internal combustion engines.

A high-pressure pump for a fuel injection system of air-compressing, auto-ignition internal combustion engines is known from the German patent specification DE 10 2009 003 054 A1. The known high-pressure pump has at least one pump assembly and a drive shaft, which comprises at least one cam associated with the pump assembly. The pump assembly comprises a roller which has a roller surface. The roller is thereby disposed on a running surface of the cam. A rolling strength of the roller on the roller surface of the roller and a rolling strength of the running surface of the cam are specified as being at least approximately equally great. As a result, an improved durability of the cam and the roller is achieved. The cam and the roller are particularly designed in an improved manner with regard to the pulsating load that occurs during operation.

In the case of a high-pressure pump, as it is known from the German patent specification DE 10 2009 003 054 A1, it is conceivable that two pump assemblies are associated with a cam. It is furthermore conceivable that, due to the cylinder cutoff function, every other delivery stroke of the high-pressure pump is no longer removed because a corresponding injection no longer occurs into the internal combustion engine. As a result, the disadvantage arises that the pressure wave load and the pressure wave formation increase due to the pump delivery strokes. In addition, the targeted and still synchronous injection strokes can be disturbed.

### SUMMARY OF THE INVENTION

The high-pressure pump according to the invention and an arrangement comprising the pump have the advantage that an improved functionality is made possible. A stress on the components of the high-pressure pump can particularly be reduced during a cylinder cutoff or something similar.

It is advantageous if the first inlet valve is designed as an electrically actuated suction valve. It is also advantageous if the second inlet valve is designed as an electrically actuated suction valve. In this regard, a control unit can be provided which is used to actuate the first inlet valve and/or the second inlet valve. Provided other inlet valves are provided for further pump assemblies, such a control unit can also be used to actuate such further inlet valves, which likewise can be designed as electrically actuated suction valves.

It is advantageous if the drive shaft has a cam which is used to drive the first pump assembly and to drive the second pump assembly. The two pump assemblies can thus be driven by a single cam of the drive shaft. One or a plurality of further cams can also be provided here, which are used to drive additional pump assemblies. In a modified embodiment, the first pump assembly and the second pump assembly can, however, also be driven by a first cam and a second cam of the drive shaft.

It is furthermore advantageous if the second inlet valve is designed as a controlled second inlet valve and if fuel pumping by the second pump assembly can at least substantially be interrupted by the second inlet valve in the partial-load operating mode. In this way, the fuel pumping by the first pump assembly or the fuel pumping by the second pumping assembly can be selectively interrupted. As a result, a reduced load on the components in the region of the first pump assembly as well as on components in the region of the second pump assembly is possible. To this end, the interruptions can alternately take place at the inlet valves in a targeted manner. In so doing, a uniform distribution of load is possible between the pump assemblies over the service life thereof.

In an advantageous manner, the control unit, in the partial-load operating mode, can carry out an actuation of the first inlet valve and if need be the second inlet valve in synchronization with a cylinder cutoff for an internal combustion engine. The fuel can thus at least substantially be delivered which is taken in by the internal combustion engine. As a result, the pressure wave load and the pressure wave formation, which develop by means of the pump delivery strokes into a fuel distributor rail or something similar, decrease in the high-pressure system, and a disturbance of the injection-synchronous injection strokes is prevented. Thus, a cylinder cutoff function for the internal combustion engine can particularly be supported.

It is also advantageous if the control unit, in the partial-load operating mode, carries out an actuation of the first inlet valve and if need be an actuation of the second inlet valve in synchronization with an actuation of an electrical pre-feed pump, which delivers fuel to the first inlet valve and the second inlet valve. In this case, the pre-feed pump can be designed as an electrical fuel pump. As a result, a cylinder cutoff of the internal combustion engine can, for example, take place on the system side uniformly and synchronously with the high-pressure pump and with a closed-loop or open-loop control of the pre-feed pump. In a modified embodiment, another pre-feed pump can, however, also be used instead of an electric fuel pump.

It is, therefore, possible for fuel to be delivered via all of the pump assemblies in the full-load range of the internal combustion engine; whereas fuel is delivered to the internal combustion engine only via a portion of the pump assemblies in a low- and partial-load range of the internal combustion engine. The high-pressure pump can hereby pump fuel into a fuel distributor, in particular a fuel distributor rail. The high-pressure pump preferably pumps fuel into the fuel distributor and therefore to the fuel injection valves in a manner which is injection-synchronous and temporally matched to the firing order of the combustion chambers. This can be achieved in the full-load range as well as in the low- and partial-load range, in particular during a cylinder cutoff.

Thus, a temporary, load dependent cutoff of at least one pump assembly of the high-pressure pump is possible. The load dependent deactivation of at least one pump assembly takes place here in the low- and partial-load range via a correspondingly designed system function. Such a system function can be implemented within the control unit and, as the case may be, adapted to the respective application. By means of this system function, it is possible to cutoff the pump assemblies by means of the corresponding actuation of the associated inlet valves in the sense of zero delivery.

The energy consumption of the high-pressure pump, the heat generation and the noise emissions can also be reduced, and the robustness of the high-pressure pump can be increased.

Advantages thus result with regard to the functionality of the high-pressure pump as well as with regard to the reduction of the energy consumption and the formation of carbon dioxide which is associated therewith. This is facilitated by an ideal injection synchronicity without disturbing pressure waves in combination with a possible cylinder cutoff of the internal combustion engine. In this case, the cylinder cutoff can take place on the system side uniformly and synchronously with the high-pressure pump and the closed-loop or open-loop control of the electric pre-feed pump. Depending on the design of the inlet valves, in particular the electric suction valves, a reduction in the power consumption and therefore a reduction in the carbon dioxide generated can be achieved. In addition, the frictional heat generated can be reduced. The frictional heat can occur here between a roller and the associated roller support, a slide bearing and the drive shaft as well as between a tappet body and a housing wall. The reduced frictional heat occurs in the pump assembly which is virtually cut off. Hence, the required amount of cooling and lubrication is also reduced. The generation of carbon dioxide is furthermore reduced. The improved functionality and the reduction in the energy requirements are also facilitated by a reduction in the required drive torque as well as by an increase in the hydraulic efficiency in the partial-load operating mode of the high-pressure pump, because the ratio of liquid volumes to be compressed to the dead volume in the active pump assembly is more favorable than a partial pumping of both pump assemblies, which is divided particularly between two pump assemblies and is lower in each case. The individual, active pump assembly acts in this case virtually better than a hydraulic spring. A reduction in noise emissions can furthermore be achieved depending on the control strategy, operating principle and constructive implementation of at least one electrical suction valve. A noise that can be described as a water hammer can also be prevented, and the opening and closing of the inlet valve and the outlet valve of the inactive pump assembly is omitted if the internal combustion engine is operating in the low- and partial-load operating mode.

A further advantage is the increase in robustness and an increase in service life which is associated therewith. In a particularly advantageous manner, a reduced load on the components, in particular on the drive components, of the high-pressure pump can be achieved. In so doing, the pump assemblies can also be alternately cut off in a targeted manner in order to distribute the load or, respectively, the load relief of the affected individual components, in particular valves, sealing seats, drive rollers and tappet bodies, over the service life thereof uniformly between the pump assemblies and the associated elements and to reduce the stress cycles. This too leads to a reduction in the Hertzian stress. A reduced material stress on the contact surface at the cam furthermore results because the number of overrolling cycles under load drop. In addition, a roller load on the cam of the drive shaft which is more uniform and distributed over a greater crank angle results on account of the higher individual delivery rate of the pump assembly that is not cut off. This also leads to a reduced material stress on the cam contact surface. The service life limits of the rolling strength as well as a material fatigue of the cam contact surface and the roller are potentially raised. Furthermore, a reduction in wear results in the region of the valve components and valve sealing seats. A reduced wobbling of the shaft can additionally be achieved, which results in a reduced load on the shaft sealing ring or the like. The number of deflections of the drive shaft can furthermore be reduced.

### BRIEF DESCRIPTION OF THE DRAWINGS

Preferred exemplary embodiments of the invention are explained in greater detail in the following description with the aid of the attached drawings, in which corresponding elements are provided with analogous reference signs. In the drawings:

FIG. 1 shows an arrangement comprising a high-pressure pump and an internal combustion engine in a schematic depiction of selected parts according to one exemplary embodiment of the invention and

FIG. 2 shows a drive shaft comprising a cam of the high-pressure pump depicted in FIG. 1 of the exemplary embodiment of the invention for the purpose of explaining the functionality of the invention.

### DETAILED DESCRIPTION

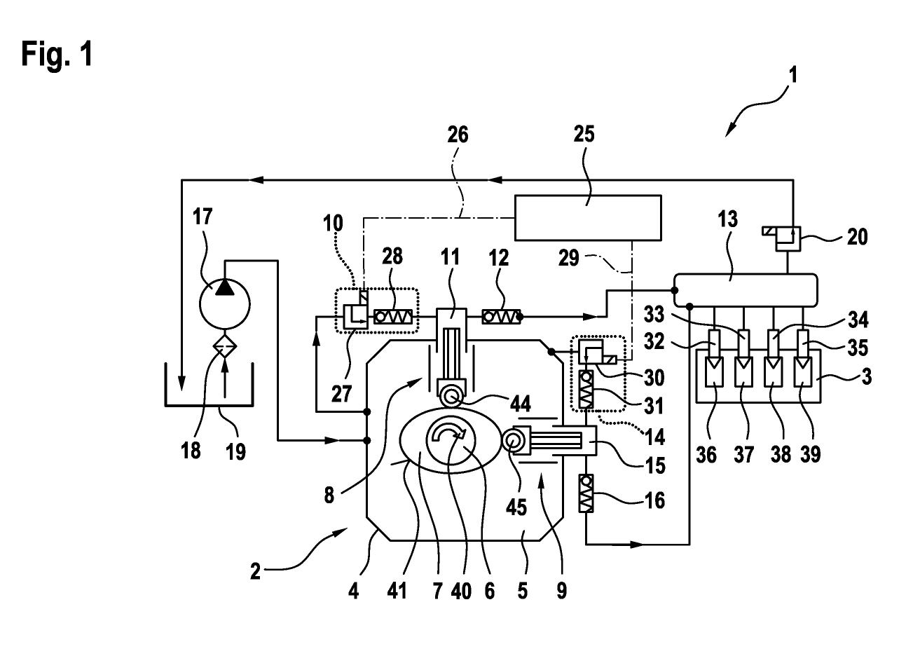

FIG. 1 shows an arrangement 1 comprising a high-pressure pump 2 and an internal combustion engine 3 in a schematic depiction of selected parts according to one exemplary embodiment. The high-pressure pump 2 can particularly be designed as a radial or in-line piston pump. The arrangement 1 can particularly be designed as a fuel injection system 1 and be used for air-compressing, auto-ignition internal combustion engines 3.

The high pressure pump 2 has a pump housing 4, in which a drive chamber 5 is configured. A drive shaft 6 comprising a cam 7 is mounted in the pump housing 4. The cam 7 is designed as a dual cam 7 in this exemplary embodiment. Corresponding to the respective configuration, the cam 7 can be designed in this case as a multiple cam. In addition, the term cam also refers to a configuration of the cam 7, in which the drive shaft 6 has an eccentric section or something similar.

The high-pressure pump 2 has a first pump assembly 8 and a second pump assembly 9 which can be driven by the cam 7 of the drive shaft 6. A first inlet valve 10 is associated with the first pump assembly 8. During operation, fuel can be led into a first working chamber 11 of the first pump assembly 8 via the inlet valve 10. After a suction phase, the fuel is compressed in the pump working chamber 11 by the first pump assembly 8 and is delivered under high pressure via a first outlet valve 12 into a fuel distributor 13. The fuel distributor 13 can particularly be designed as a fuel distributor rail 13.

A second inlet valve 14 is furthermore provided, via which fuel can be led into a pump working chamber 15 of the second pump assembly 9. By means of the second pump assembly 9, the fuel can then be compressed and delivered via a second outlet valve 16 into the fuel distributor 13.

During operation, fuel subjected to high pressure is situated in the fuel distributor 13.

In this exemplary embodiment, the fuel moves via the drive chamber 5 to the inlet valves 10, 14. The fuel is suctioned here thorough a filter 18 from a tank 19 by a pre-feed pump 17 and delivered into the drive chamber 5. The pre-feed pump 17 is designed as an electric fuel pump 17.

A pressure limiting valve 20 is furthermore provided via which fuel, if need be, moves out of the fuel distributor 13 back into the tank 19 if a predefined maximum pressure of the fuel in the fuel distributor 13 is exceeded.

The arrangement 1 has a control unit 25, which is connected to an electrical actuator 27 of the first inlet valve 10 via a signal line 26. The electrical actuator 27 can, for example, be an electromagnet. The first inlet valve 10 furthermore has a valve element 28, which is subjected to pressure in the closing direction by means of a spring. The control unit 25 is furthermore connected to an electrical actuator 30 of the second inlet valve via a signal line 29. The second inlet valve 14 furthermore has a valve element 31, which is subjected to pressure in the closing direction by means of a spring. By activating the actuator 27 or the actuator 30, the valve element 28 of the first inlet valve 10 or the valve element 31 of the second inlet valve 14 can be opened against the respective spring force and thus a fuel pumping by the first pump assembly 8 or, respectively, the second pump assembly 9 can be interrupted. The respective valve element 28 or 31 remains open in the process even during the delivery stroke of the respective pump assembly 8 or 9. As a result, a cutoff of the respective pump assembly 8, 9 can virtually be achieved during operation.

The control unit 25 is furthermore connected to the electric pre-feed pump 17 and to the fuel injection valves 32 to 35. By activating the fuel injection valves 32 to 35, fuel from the fuel distributor 13 can be injected into the associated combustion chambers 36 to 39 of the internal combustion engine 3.

The controlled first inlet valve 10 is therefore provided for the first pump assembly 8; and the second controlled inlet valve 14 is provided for the second pump assembly 9. Particularly if the internal combustion engine 3 is operating in the full-load mode, fuel is then pumped by the pump assemblies 8, 9 to the fuel distributor 13. In this case, it is possible for fuel to be pumped via the pump assemblies 8, 9 into the fuel distributor 13 in synchronization with the injection of fuel by means of the fuel injection valves 32 to 35.

In a partial-load operating mode, fuel pumping by the first pump assembly 8 can be interrupted by the first inlet valve 10 by the actuator 27 being activated and the valve element 28 being opened. In this exemplary embodiment, fuel pumping by the second pump assembly 9 can also be interrupted by the second inlet valve 14 in the partial-load operating mode by the actuator 30 being activated and the valve element 31 being opened.

A cutoff of two cylinders of the internal combustion engine 3 can, for example, take place in the partial-load operating mode, so that, for example, the fuel injection valves 34, 35 are no longer actuated. On the one hand, the fuel quantity is then reduced over the entire injection cycle of the injection valves 32 to 35. On the other hand, an injection-synchronous pumping is advantageous. This is achieved by cutting off the fuel pumping via the first pump assembly 8 or the second pump assembly 9. This is the case because the fuel quantity is then accordingly reduced and an injection-synchronous pumping can be achieved.

In so doing, the control unit 25 can actuate the first inlet valve 10 and the second inlet valve 14 in a partial-load mode over the service life thereof in such a way that the interruption of the fuel pumping performed by the first pump assembly 8 by means of the first inlet valve 10 and the interruption of the fuel pumping performed by the second pump assembly 9 by means of the second inlet valve occur approximately in the same proportions. Hence, the pump assemblies 8, 9 can be uniformly relieved of load.

In the partial-load mode, the control unit 25 can particularly actuate the first inlet valve 10 and the second inlet valve 14 such that the interruption of the fuel pumping by the first pump assembly 8 and the interruption of the pumping by the second pump assembly 9 occur alternately. In the process, the control unit 25 can in each case coordinate the synchronization with the injection of fuel.

In the partial-load mode, the control unit 25 therefore carries out an actuation of the first inlet valve 10 and the second inlet valve 14 in synchronization with the cylinder cutoff for the internal combustion engine 3.

In the partial-load mode, the control unit 25 can also additionally carry out an actuation of the first inlet valve 10 and the second inlet valve 14 in synchronization with an actuation of the electric pre-feed pump 17, which pumps the fuel to the inlet valves 10, 14.

If the control unit 25 cuts off a portion of the fuel injection valves 32 to 35 during a cylinder cutoff for the internal combustion engine 3 in order to interrupt an injection of fuel via the cutoff portion of the fuel injection valves 32 to 35, a reduction of the required fuel quantity and simultaneously an injection-synchronous pumping of the fuel can therefore be implemented in an advantageous manner. Thus, an improved functionality and a reduction in the energy consumption result. In addition, an increase in the robustness and an increase in the service life of the high-pressure are thereby achieved at the same time.

In an advantageous manner, the first inlet valve 10 can be designed as an electrically actuated suction valve 10, wherein the fuel is led via the opened valve element 28 into the pump working chamber 11 during an intake stroke of the first pump assembly 8. The second inlet valve 14 can furthermore be designed as an electrically actuated suction valve 14 in an advantageous manner. In this case, the fuel can be led via the opened valve element 31 into the pump working chamber 15 during an intake stroke of the second pump assembly 9. During the intake stroke of the pump assemblies 8 and 9, the respective actuator 27 or 30 does not need to be activated by the control unit 25 because the respective valve element 28 or 31 is opened against the spring force as a result of the pressure difference between the intake of the fuel pump 17 and the pump working chamber 11 or 15. If the inlet valve 10 or 14 is supposed to be open during the delivery stroke of the respective pump assembly 8 or 9 in order to interrupt a pumping of fuel, the respective actuator 27 or 30 is then actuated by the control unit 25.

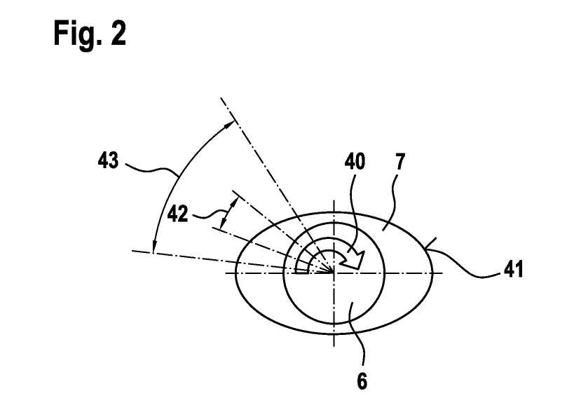

FIG. 2 shows the drive shaft 8 comprising the cam 7 of the high-pressure pump 2 depicted in FIG. 1 of the exemplary embodiment for the purpose of explaining the functionality of the exemplary embodiment. A possible rotational direction 40 of the drive shaft 8 is illustrated here by an arrow 40. In order to explain the functionality of the invention, regions 42, 43 are depicted by way of example on a contact surface 41 of the cam 7. The region 42 lies here within the region 43 and is furthermore significantly smaller than the region 43.

If the pumping via the two pump assemblies 8, 9 is maintained in a conventional manner during a partial-load operation of the internal combustion engine 3 in which, if need be, a portion of the fuel injection valves 32 to 35 can be cut off, the following situation is then conceivable. Due to the reduced fuel requirements, only a partial pumping by the pump assemblies 8, 9 takes place during the delivery stroke because the inlet valves 10 and 14 remain open during a portion of the delivery stroke so that pumping does not occur and are closed only during a portion of the delivery stroke so that only a partial pumping occurs. As a result, the region 42 of the two pump assemblies 8, 9 is, for example, rolled over twice under load during a rotation of the drive shaft 6. The load is concentrated here on the smaller region 42.

In contrast thereto, a deactivation of one of the pump assemblies 8, 9 takes place during the operation of the high-pressure pump 2 of the arrangement 1 corresponding to the exemplary embodiment. Thus, only one of the pump assemblies 8, 9 pumps with a degree of filling that is accordingly increased. A partial filling is thus prevented despite the reduced fuel requirements. The region 43 is therefore rolled over once under load during a rotation of the drive shaft 6, the load being distributed over the larger region 43. In so doing, a pressure build-up which takes place more gently and a more uniform loading of the contact surface 41 occur simultaneously. The rollers 44, 45 provided on the pump assemblies 8, 9 are thus likewise more uniformly loaded.

The invention is not limited to the exemplary embodiments described.

1. A high-pressure pump (2), comprising a first pump assembly (8), at least one second pump assembly (9), a drive shaft configured to drive the first pump assembly (8) and the second pump assembly (9), a first inlet valve (10) for a pump working chamber (11) of the first pump assembly (8), and at least one second inlet valve (14) for a pump working chamber (15) of the second pump assembly (9),
characterized
in that at least the first inlet valve (10) is a controlled inlet valve (10) and that fuel pumping by the first pump assembly (8) can be at least substantially interrupted by the first inlet valve (10) in a partial-load operating mode.

2. The high-pressure pump according to claim 1,
characterized
in that the first inlet valve (10) is an electrically actuated suction valve (10) and/or that the second inlet valve (14) is an electrically actuated suction valve (14).

3. The high-pressure pump according to claim 1,
characterized
in that the drive shaft (6) has a cam (7) which is configured to drive the first pump assembly (8) and to drive the second pump assembly (9).

4. The high-pressure pump according to claim 1,
characterized
in that the second inlet valve (14) is a controlled second inlet valve (14) and that fuel pumping by the second pump assembly (9) can be at least substantially interrupted by the second inlet valve (14) in the partial-load operating mode.

5. The high-pressure pump according to claim 4,
further comprising a control unit (25) which, in the partial-load operating mode, actuates the first inlet valve (10) and the second inlet valve (14) over a service life thereof in such a way that interruption of the fuel pumping performed by the first pump assembly (8) by means of the first inlet valve (10) and interruption of the fuel pumping performed by the second pump assembly (9) by means of the second inlet valve (14) takes place approximately in the same proportions.

6. The high-pressure pump according to claim 4,
further comprising a control unit (25) which actuates the first inlet valve (10) and the second inlet valve (14) in such a way that interruption of the fuel pumping performed by the first pump assembly (8) by means of the first inlet valve (10) and interruption of the fuel pumping performed by the second pump assembly (9) by means of the second inlet valve (11) occur alternately.

7. The high-pressure pump according to claim 1,
further comprising a control unit (25) which, in the partial-load operating mode, carries out an actuation at least of the first inlet valve (10) in synchronization with a cylinder cutoff for an internal combustion engine (3).

8. The high-pressure pump according to claim 1,
further comprising a control unit (25) which, in the partial-load operating mode, carries out an actuation at least of the first inlet valve (10) in synchronization with an actuation of an electric pre-feed pump (17), which delivers fuel to the first inlet valve (10) and to the second inlet valve (14).

9. A fuel injection system comprising a high-pressure pump (2) according to claim 1, a pre-feed pump (17), via which fuel can be delivered to the first inlet valve (10) and the second inlet valve (14), and comprising a plurality of fuel injection valves (32-35).

10. The fuel injection system according to claim 9,
further comprising a control unit (25) which interrupts an injection of fuel for a portion of the fuel injection valves (32-35) into associated combustion chambers (36-39) of the internal combustion engine (3).
